(19) United States
(12) Patent Application Publication
(10) Pub. No.: US 2013/0087313 A1
(43) Pub. Date: Apr. 11, 2013

(54) FLUID COOLING MODULE

(71) Applicants: Timothy Michael Rau, Sacramento, CA (US); Glenn C. Simon, Auburn, CA (US)

(72) Inventors: Timothy Michael Rau, Sacramento, CA (US); Glenn C. Simon, Auburn, CA (US)

(21) Appl. No.: 13/386,971

(22) PCT Filed: Jun. 29, 2010
(86) PCT No.: PCT/US10/40453

§ 371 Date: Jan. 25, 2012

(51) Int. Cl. F28F 1/40; B23P 15/26

(52) U.S. Cl. CPC F28F 1/40; B23P 15/26
USPC 165/109.1; 29/890.045

(57) ABSTRACT

A fluid cooling module includes tubing and a turbulence structure. The tubing is configured to contain a flowing fluid. The turbulence structure disposed inside the tubing and configured to increase fluid movement within the tubing as the flowing fluid flows over the turbulence structure to thereby generate turbulence in the flowing fluid.

### BACKGROUND

Many types of electronic equipment employ cooling in order to operate optimally. Various heat management techniques are employed to prevent undesirable rises in operating temperatures of certain types of electronic equipment. It is common for electronic equipment to be cooled by a fluid (e.g., a gas, such as air and/or a liquid, such as water). Many typical fluid cooling systems include tubing that contains flowing fluid that extracts heat from the electronic equipment. It is desirable to optimize the heat transfer from the electronic equipment to the flowing fluid in order to allow for higher wattages to be employed in the electronic equipment.

Previous fluid cooling systems include tubing that is custom extruded to optimize the tube shape or tubing manufactured with increased roughness within the tube. Both of these types of tubing can provide improved heat transfer from the electronic equipment to the flowing fluid compared to standard tubing, but are much more expensive. It is desirable to improve the heat transfer from the electronic equipment to the flowing fluid at a lower cost than existing custom or specially manufactured solutions.

For these and other reasons, a need exists for the present invention.

### BRIEF DESCRIPTION OF THE DRAWINGS

FIG. 1 is a perspective view of a fluid cooling module in an electronic system according to one embodiment.

FIG. 2 is an enlarged longitudinal cross-sectional view of the fluid cooling module of FIG. 1.

FIG. 3 is a cross-sectional view of the fluid cooling module of FIG. 2 taken along line 3-3.

FIG. 4 is a perspective view of the fluid cooling module in the electronic system according to the embodiment of FIG. 1.

FIG. 5 is flow diagram of a process of fluid cooling electronic components according to one embodiment.

### DETAILED DESCRIPTION

In the following detailed description, reference is made to the accompanying drawings which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that the features of the various exemplary embodiments described herein may be combined with each other, unless specifically noted otherwise.

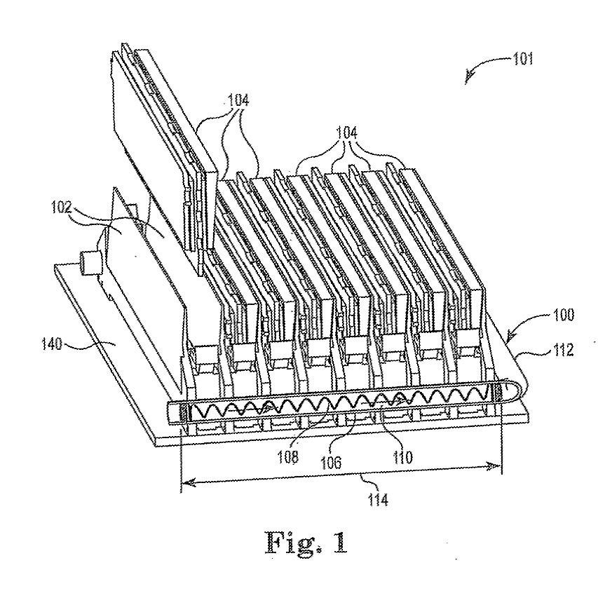

FIG. 1 is a perspective view of a fluid cooling module 100 in an electronic system 101 according to one embodiment. In one embodiment, electronic system 101 is a memory device in a computer system, such as a server. In one embodiment, electronic system 101 includes one or more cold plate 102, electronic components 104, tubing 106, and a turbulence structure 108. In one embodiment, each electronic component 104 (e.g., a removable memory board) is removable from electronic system 101. Each removable electronic component 104 is thermally coupled to cold plate 102. Tubing 106 is configured to contain flowing fluid 110 which together form a fluid loop 112. Tubing 106 is thermally coupled to cold plate 102. Turbulence structure 108, disposed inside tubing 106, is configured to increase movement (i.e., turbulence) of flowing fluid 110 within tubing 106.

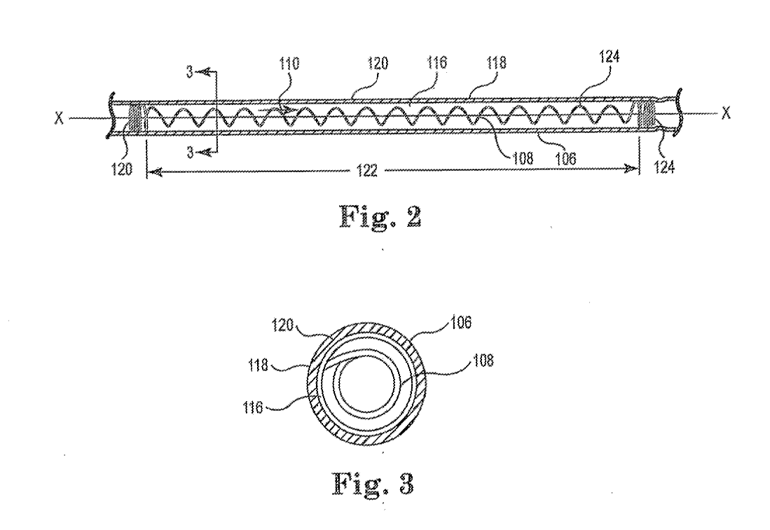

Referring to FIGS. 1-3, turbulence structure 108 is assembled within tubing 106. In one embodiment, multiple turbulence structures 108 are assembled with in tubing 106 to increase the rate of heat transfer between flowing fluid 110 and tubing 106. In one embodiment, turbulence structure 108 extends along the entire length of fluid loop 112. In one embodiment, turbulence structure 108 has a length, indicated by arrows 114, that is shorter than the entire length of fluid loop 112 and is positioned at a desired selected location within tubing 106 including along one or more bends in tubing 106 and/or along one or more straight lengths of tubing 106. In one embodiment, the placement of turbulence structures 108 within tubing 106 is selected to optimize the rate of heat transfer from electronic components 104 to flowing fluid 110. In one embodiment, turbulent structure 108 increases the roughness of interior 116 of tubing 106.

Opposing ends 120, 124 of turbulence structure 108 are secured in the desired selected location of tubing 106 with end stops, crimping a section of tubing 106, clamps or other suitable securing mechanism. In one embodiment, turbulence structure 108 is frictionally fit inside tubing 106. In one embodiment, turbulence structure 108 is frictionally fit only at opposing ends 120, 124, leaving an intermediate portion 122 movable along a central axis X of tubing 106. After being assembled into tubing 106, turbulence structure 108 includes portions which contact corresponding portions of an interior 116 of tubing 106. In one embodiment, tubular structure 108 is assembled and configured to increase contact surface within tubing 106 to optimize the rate of heat dissipation from electronic components 104 to flowing fluid 110 to tubing 106 to air in the environment surrounding tubing 106.

In one embodiment, turbulence structure 108 includes sufficiently large fluid openings to reduce back pressure to suitable levels. In one embodiment, turbulence structure 108 is formed from a coiled wire or spring having a gauge suitable for bending within tubing 106 without substantially restricting flow of flowing fluid 110. In one embodiment, turbulence structure 108 comprises spiraled wire forming a helix shaped structure having spirals 124. In one embodiment, spirals 124 of the helix shaped structure are closer together at ends 120 and 124 than intermediate portion 122. The helix shaped structure can be a circular helix or a conical helix.

In one embodiment, turbulence structure 108 includes an alternatively spaced rotational member along its circumference. In one embodiment, turbulence structure 108 is formed of a suitable material (e.g., plastic or metal) that is non-reactive with fluid 110 and tubing 106. In one embodiment, turbulence structure 108 may be cut to any suitable length from a single common extrusion.

Tubing 106 has interior 116 and exterior 118 formed by tubing walls 120. Interior 116 of tubing 106 is formed to contain flowing fluid 110 and turbulence structure 108. Exterior 118 provides a contact surface to air in the environment surrounding tubing 106, which dissipates heat from flowing fluid 110 to the air.

In one embodiment, tubing 106 has a circular cross-section, although other embodiments include other suitable cross-sectional configurations, such as oval, rectangular, or square. The cross-sectional size of tubing 106 and the thickness of tubing walls 120 can be determined by a number of factors including, but not limited to, the type of material used to form the tubular body walls 120, the radius of fluid loop 112, the type of fluid 110, and the desired heat transfer.

Tubing 106 is configured to contain flowing fluid 110 and allow fluid 110 to circulate through the tubing. In one embodiment, tubing 106 is formed as a hollow tube. Tubing 106 is sized appropriately to accommodate the desired rate of heat dissipation from the electronic components of electronic system 101. In one embodiment, tubing 106 is standard tubing. Embodiments of tubing 106 include semi-rigid, flexible, and/or rigid tubing. Embodiments of tubing 106 can be made of copper, brass, aluminum, plastic such as polyvinyl chloride, rubber, stainless steel, or other suitable heat conductive material.

Fluid 110 can be a gas (e.g., air) and/or a liquid (e.g., water). In one embodiment, fluid 110 has a boiling point lower than the temperature of a heat source (e.g., electronic components 104) and higher than a minimum operating temperature of fluid 110. The relationship between evaporating heat, the boiling point of fluid 110, the minimum operating temperature of fluid 110, and the temperature of the heat source can be considered in selecting a suitable fluid 110. Surface tension, density, viscosity can also be considered when selecting a suitable fluid 110.

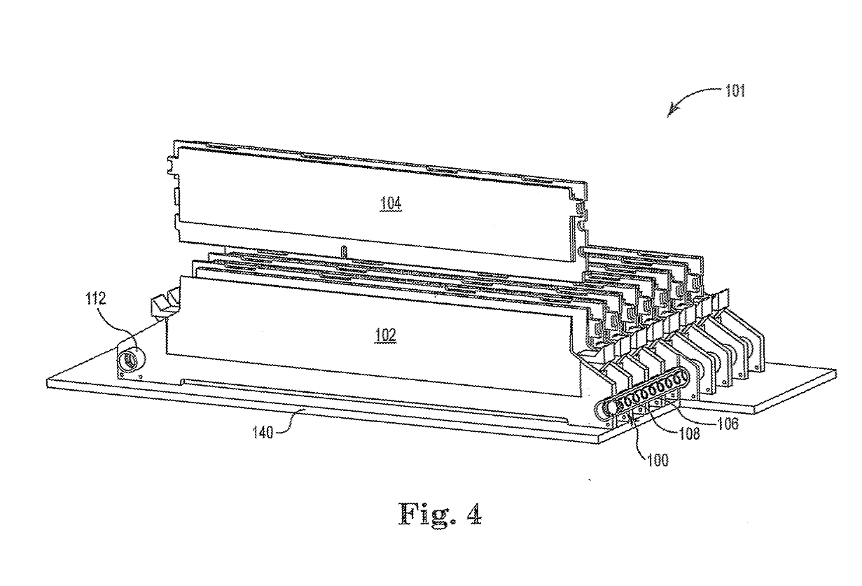

As illustrated in FIGS. 1 and 4, tubing 106 is configured in fluid loop 112 according to the arrangement of electronic components 104 on a system board 140 in order to thermally contact electronic components 104 to provide heat dissipation from the electronic components. Tubing 106 can be arranged in various configurations, for example, looped around electronic components 104 in a serpentine configuration. In one embodiment, during the manufacture of fluid cooling module 100, turbulence structure 108 is installed within tubing 106 before tubing 106 is bent, soldered, or formed into fluid loop 112 and assembled into electronic system 101.

In one embodiment, tubing 106 is configured in a fluid loop 112 around a perimeter of a series of electronic elements 104 and cold plates 102. In one embodiment, tubing 106 is mechanically and thermally coupled to cold plate 102 by a mechanical mechanism, such as welding or soldering tubing 106 to various heat spreaders and heat transfer plates, stand-off clamps, or clips that surround tubing 106 and attach to cold plate 102. In one embodiment, cold plate 102 includes penetrations through which tubing 106 passes. In one embodiment, tubing 106 is attached to each of the opposing ends of cold plates 102. Cold plates 102 can comprise copper or other suitable heat conducting material.

In one embodiment, system board 140 provides an auxiliary thermal contact between tubing 106 and heat generating electronic components 104 for improved heat dissipation. In one embodiment, system board 140 is a generally rectangular, planar body. In one embodiment, system board 140 is a printed circuit board. In one embodiment, cold plate 102 is assembled with system board 140. Cold plates 102 are thermally coupled to electronic components 104. In one embodiment, cold plates 102 and electronic components 104 are assembled in a series. In one embodiment, system board 140 includes a series of mounting locations suitable for mounting a series of removable electronic components 104, such as Dual In-line Memory Modules (DIMMs), one or more microprocessor boards, one or more peripheral component interface board, and/or one or more video interface board.

Heat from electronic components 104 is transferred to the tubing 106, which thermally contacts electronic components 104 via cold plates 102, and the heat then transfers to flowing fluid 110 inside tubing 106. Heat dissipation occurs as the heat is transferred to flowing fluid 110 and then is transferred to the contact surface of exterior 118 of tubing 106 and is dissipated to the air in the environment surrounding tubing 106. The movement of flowing fluid 110 through and by turbulence structure 108 within tubing 106 provides fluid turbulence and increased rate of heat transfer between flowing fluid 110 and tubing 106. In one embodiment, turbulence structure 108 is assembled in a selected location within tubing 106 to optimize the fluid turbulence to thereby increase the rate of heat transfer between flowing fluid 110 and tubing 106. Design parameters of turbulence structure 108, such as the length, shape or the configurations can also be modified in order to optimize the rate of heat dissipation. Increasing the rate of the heat transfer from electronic components 104 to flowing fluid 110 to the air allows higher wattages to be employed in electronic system 101.

Other embodiments of turbulence structures similar to turbulence structure 108 can be employed in engines, pipes, and other systems having fluid carrying pathways where turbulence in the flowing fluid can improve heat dissipation from heat generating components in the system to the flowing fluid to the air in the environment surrounding the fluid carrying pathways.

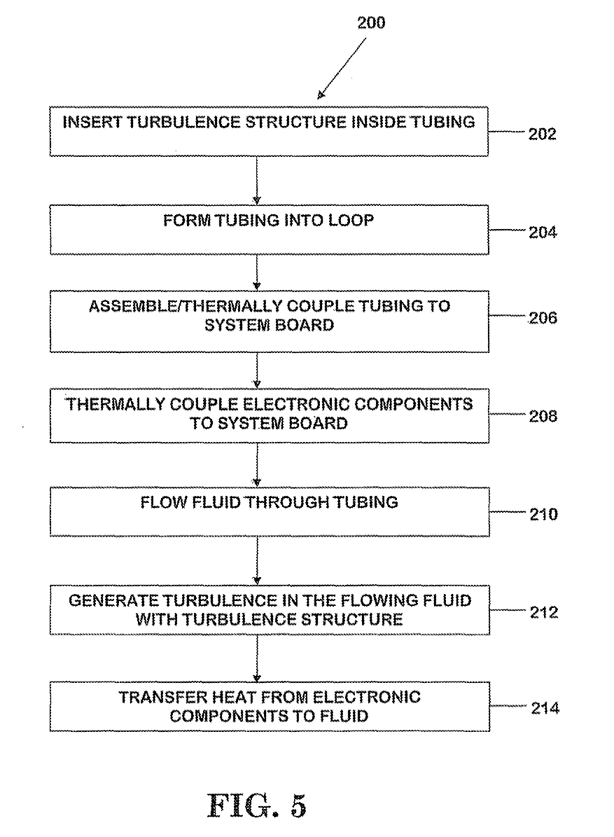

FIG. 5 illustrates one embodiment of a process 200 of fluid cooling electronic components 104. At 202, at least one turbulence structure 108 is inserted into tubing 106. In one embodiment, the location inside tubing 106 to insert at least one turbulence structure 108 is selected to optimize the rate of heat transfer of from electronic components 104 to the fluid to the tubing to the air in the environment surrounding the tubing. In one embodiment, at least one turbulence structure 108 is secured within tubing 106 by bending tubing 106. At 204, tubing 106 is formed into a loop 112. At 206, tubing 106 is assembled and thermally coupled to system board 140. At 208, electronic components 104 are thermally coupled to system board 140. At 210, fluid flows through tubing 106. At 212, fluid movement is increased within tubing 106 to generate turbulence in the flowing fluid 110 with the turbulence structure 108. At 214, heat is transferred from the electronic components 104 to flowing fluid 110 to tubing 106 to the air in the environment surrounding the tubing.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. A fluid cooling module, comprising:
tubing configured to contain a flowing fluid; and
a turbulence structure disposed inside the tubing and configured to increase fluid movement within the tubing as the flowing fluid flows over the turbulence structure to thereby generate turbulence in the flowing fluid.

2. The module of claim 1, wherein the turbulence structure is friction fit at a first end and a second end of the turbulence structure.

3. The module of claim 1, wherein the turbulence structure is friction fit between a first end and a second end of the turbulence structure.

4. The module of claim 1, wherein the turbulence structure is secured within the tubing.

5. The module of claim 1, wherein the turbulence structure comprises a helix shaped structure.

6. The module of claim 1, wherein the turbulence structure comprises a series of angled protrusions.

7. The module of claim 1, wherein the turbulence structure comprises a coiled spiral structure with a varying circumference.

8. The module of claim 1, wherein the turbulence structure comprises a sleeve having a variegated circumference.

9. The module of claim 1, wherein the turbulence structure comprises a series of protrusions, wherein portions of the series of protrusions contact corresponding interior portions of the tubing at rotated locations of the tubing.

10. The module of claim 1, wherein the tubing and turbulence structure comprise differing materials.

11. An electronic system comprising:
a cold plate;
an electronic component thermally coupled to the cold plate;
tubing configured to contain a flowing fluid such that the tubing and flowing fluid together form a fluid loop thermally coupled to the cold plate; and
a turbulence structure disposed inside a length of the tubing and configured to increase movement of the flowing fluid within the tubing to thereby generate turbulence in the flowing fluid.

12. The electronic system of claim 11, wherein the turbulence structure is configured within the tubing at cold plate connections.

13. A method of fluid cooling electronic components, comprising:
inserting at least one turbulence structure in at least one selected location inside tubing;
forming the tubing into a loop;
assembling the tubing to a system board including thermally coupling the tubing to the system board;
thermally coupling the electronic component to the system board;
flowing fluid through the tubing;
increasing, with the turbulence structure, fluid movement within the tubing to thereby generate turbulence in the flowing fluid; and
transferring heat from the electronic components to the fluid.

14. The method of claim 13, wherein the at least one turbulence structure is secured within the tubing by bending the tubing.

15. The method of claim 13 comprising:
selecting the location inside the tubing to insert the at least one turbulence structure to optimize a rate of the transferring heat from the electronic components to the fluid.
